(19) United States
(12) Patent Application Publication
(10) Pub. No.: US 2011/0078626 A1
(43) Pub. Date: Mar. 31, 2011

(54) Contextual Presentation of Digital Media Asset Collections

(76) Inventors: William Bachman, San Jose, CA (US); Timothy Benjamin Martin, Sunnyvale, CA (US); Brian Frick, Gaithersburg, MD (US)

(21) Appl. No.: 12/568,474

(22) Filed: Sep. 28, 2009

(51) Int. Cl. G06F 17/30; G06F 3/048

(52) U.S. Cl. 715/810; 707/E17.014

(57) ABSTRACT

Methods, apparatus and systems for facilitating presentation of media asset collections with reference to larger media libraries re disclosed. In one embodiment, digital media assets that are in a media asset collection can be visually distinguished from those digital media assets available from a remote media repository that are related to but not within the media asset collection.

### BACKGROUND OF THE INVENTION

1. Field of the Invention

The present invention relates to presenting digital media assets on a display device and, more particularly, to presenting digital media asset collections in relationship to more complete collections, such as available from a media asset library.

2. Description of the Related Art

Conventionally, users of digital media assets tend to acquire digital media assets, such as music albums, television show episodes or movies. Often these acquired digital media assets are with particular arts, shows, time periods, or actors. In other words, user tends to form collections of related digital media assets. However, given the potentially larger number of digital media assets that could be considered part of a complete collection, the user collections typically will be incomplete and thus smaller than the complete collection. Unfortunately, however, there is no convenient way for users to receive guidance or feedback on the extent of their collections. While users can search, online or manually, for digital media assets that would be related to their collections, such searching can be time consuming and disjointed from those of the digital media assets the user already has in their collections. Accordingly, there is a need for improved approaches to provide guidance or feedback to users in an automated and contextual useful manner.

### SUMMARY

The invention pertains to methods, apparatus and systems for facilitating presentation of media asset collections with reference to larger media libraries. In one embodiment, digital media assets that are in a media asset collection can be visually distinguished from those digital media assets available from a remote media repository that are related to but not within the media asset collection.

Advantageously, in one embodiment, a user of a computing device can be presented, via a display device, with a visual presentation that provides visual distinction between those digital media assets that are part of a local media collection and those digital media assets that are not part of the local media collection but which are nevertheless related thereto. These additional media assets that are not part of the local media collection can be made available for acquisition from a remote media repository (e.g., a remote media library). The visual distinction can also promote acquisition of these additional media assets. For example, those of the digital media assets available from the remote media repository that are not already part of the local media collection can be readily purchased and added to the local media collection.

The digital media assets (i.e., digital media items) can pertain to video items (e.g., video files or movies), audio items (e.g., audio files or audio tracks, such as for songs (music) or audiobooks), or image items (e.g., photos).

The invention can be implemented in numerous ways, including as a method, system, device, apparatus (including computer readable medium and graphical user interface). Several embodiments of the invention are discussed below.

As a method performed by a computer to present a representation of media assets on a display screen associated with the computer, one embodiment can, for example, include at least: obtaining a superset list of media assets available from a remote media repository that satisfy at least one media asset characteristic; obtaining a subset list of media assets from a local media collection stored on the computer that satisfy the at least one media asset characteristic; comparing the subset list with the superset list to identify those of the media items in the superset list that are also in the subset list; and displaying, on the display screen, a visual representation of (i) a plurality of the media assets within the superset list of media assets from the remote media repository and (ii) a plurality of the media assets within the subset list of media assets from the local media collection. Those of the media assets within the plurality of the media assets within the superset list that are also in the subset list are able to be distinguishably displayed from those of the media assets within the plurality of the media assets within the superset list that are not also in the subset list.

As a method performed by a computer to present a representation of media assets on a display screen associated with the computer, one embodiment can, for example, include at least: identifying at least one subset of media assets from a local media library stored on the computer, the at least one subset being defined by at least one subset characteristic; displaying, on the display screen, a visual representation of a plurality of the media assets within the at least one subset of media assets from the local media library; obtaining a superset of media assets from a remote media library that satisfy the at least one subset characteristic; filtering out from the superset of media assets those of the media assets that are included within the at least one subset of media assets from the local media library; and displaying, on the display screen, a visual representation of a plurality of those media assets within the filtered superset of media assets from the remote media library.

As a computer-implemented method for visually representing media items on a display device, one embodiment can, for example, include at least: determining media identifiers for a library of media items; receiving a collection list for a predetermined collection of media items, the collection list having a collection list of media identifiers; evaluating whether the media identifiers of the library match the media identifiers of the collection list; and displaying a visual representation of the media items in the collection list in relation to media items in the library that the evaluating indicates are not in the collection list for the predetermined collection.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a computing device according to one embodiment of the invention.

FIG. 2A is an illustration of a media presentation system according to one embodiment of the invention.

FIG. 2B is an illustration of an exemplary usage of a media presentation system according to one embodiment of the invention.

FIG. 2C illustrated a first alternative presentation for a mixed media view according to one embodiment.

FIG. 2D illustrated a second alternative presentation for a mixed media view according to one embodiment.

FIG. 2E illustrated a third alternative presentation for a mixed media view according to one embodiment.

FIG. 3 is a flow diagram of a media presentation process according to one embodiment of the invention.

FIG. 4 is a flow diagram of a media presentation process according to one embodiment of the invention.

FIG. 5 is a flow diagram of a media presentation process according to one embodiment of the invention.

FIGS. 6A-6D are exemplary visual representations according to embodiments of the invention.

### DETAILED DESCRIPTION OF THE INVENTION

The invention pertains to methods, apparatus and systems for facilitating presentation of media asset collections with reference to larger media libraries. In one embodiment, digital media assets that are in a media asset collection can be visually distinguished from those digital media assets available from a remote media repository that are related to but not within the media asset collection.

Advantageously, in one embodiment, a user of a computing device can be presented, via a display device, with a visual presentation that provides visual distinction between those digital media assets that are part of a local media collection and those digital media assets that are not part of the local media collection but which are nevertheless related thereto. These additional media assets that are not part of the local media collection can be made available for acquisition from a remote media repository (e.g., a remote media library). The visual distinction can also promote acquisition of these additional media assets. For example, those of the digital media assets available from the remote media repository that are not already part of the local media collection can be readily purchased and added to the local media collection.

The digital media assets (i.e., digital media items) can pertain to video items (e.g., video files or movies), audio items (e.g., audio files or audio tracks, such as for songs (music) or audiobooks), or image items (e.g., photos).

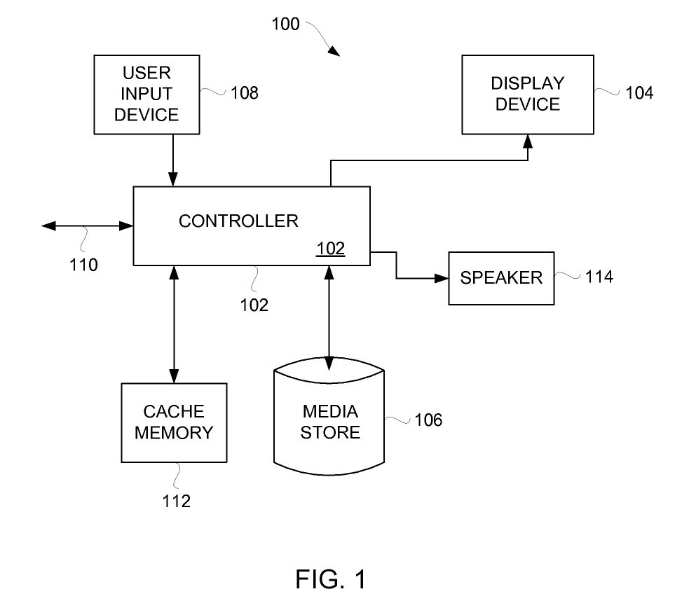

Embodiments of various aspects of the invention are discussed below with reference to FIGS. 1-6D. However, those skilled in the art will readily appreciate that the detailed description given herein with respect to these figures is for explanatory purposes as the invention extends beyond these limited embodiments.

FIG. 1 is a block diagram of a computing device 100 according to one embodiment of the invention. The computing device 100 can, for example, represent an electronic device having hardware and/or software configured to operate to browse, search, present, select, play and/or purchase digital media assets.

The computing device 100 can include a controller 102 for controlling the overall operation of the computing device 100. The controller 102 can perform instructions to provide various functions to the computing device. The computing device 100 can also further include specialized hardware components to improve its functions, capabilities or efficiency.

The computing device 100 can also include a display device 104 that acts as a visual output device. The display device 104 can be controlled by the controller 102. The computing device 100 can also include a media store 106 that provides local storage for digital media assets. Typically, the digital media assets are described with metadata but include or associate with content data that can be played. For example, the media store 106 can store metadata as well as content data for a plurality of digital media assets that are associated with the computing device 100 (or its user). The digital media assets stored in the media store 106 can be referred to as a local media collection (or a local media library).

The computing device 100 can also include a user input device 108 that can provide user input to the computing device 100, namely, the controller 102. The user input provided via the user input device 108 can serve to make user selections with respect to digital media assets presented in a display screen on the display device 104. The digital media assets being presented in the display screen on the display device 104 can be stored in the media store 106 or can be remotely acquired. The computing device 100 can include a network interface 110 that can couple to a network. The controller 102 can interact with a remote server via the network interface 110 to access metadata and possibly media content associated with media assets within a remote media repository. These remotely located media assets can pertain to a remote media library. As the metadata and possibly media content is received from the remote media repository via the remote server, the metadata and media content can be stored to a cache memory 112 so that such data can be rapidly retrieved by the controller 102. By using the cache memory 112, the ability to temporarily store (“cache”) such data allows efficient high-speed operation by the computing device 100. For example, data for one or more remote media assets can be received from a remote server and temporarily stored in the cache memory 112 until needed, expired or removed from the cache memory 112. The controller 102 can also play any of the media assets accessible to the computing device 100. Media assets, namely the content data therefore, can be obtained from the media store 106, the cache memory 112 or via the network interface 110. Visual outputs from the presentation of digital media assets and well as visual effects of media assets being played back can be displayed by the display device 104. For audio outputs, the computing device 100 further includes a speaker 114. The speaker 114 can be controller by the controller 102 to provide the desired audio outputs. The audio outputs include audio output of media assets being played back by the computing device 100.

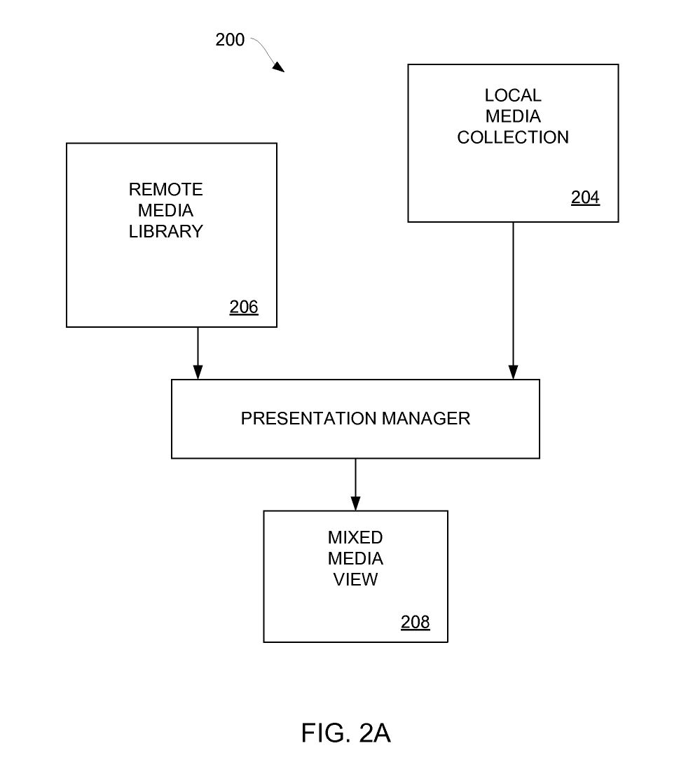

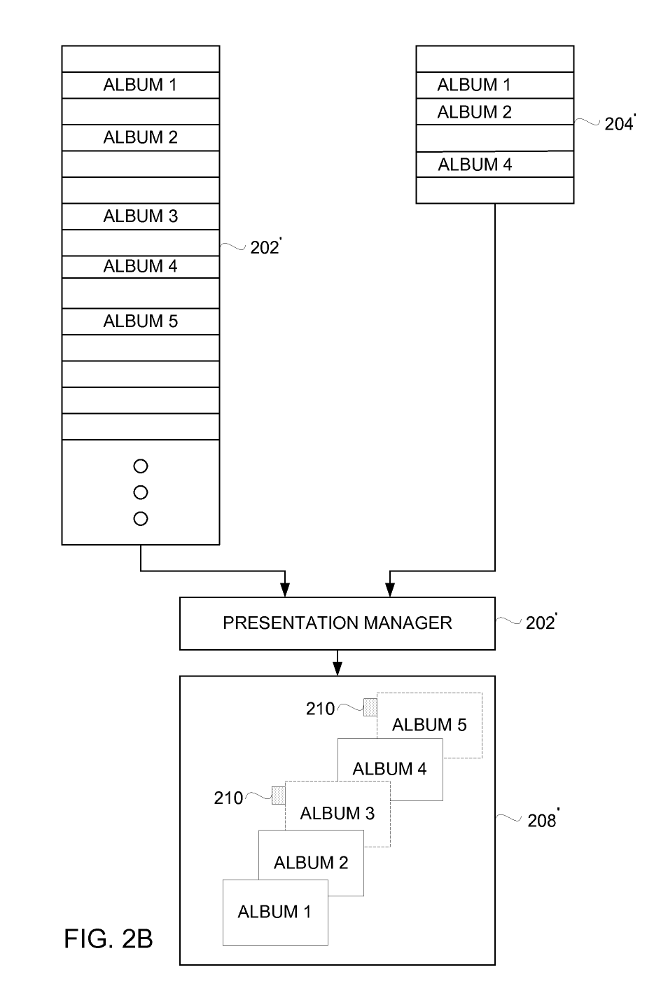

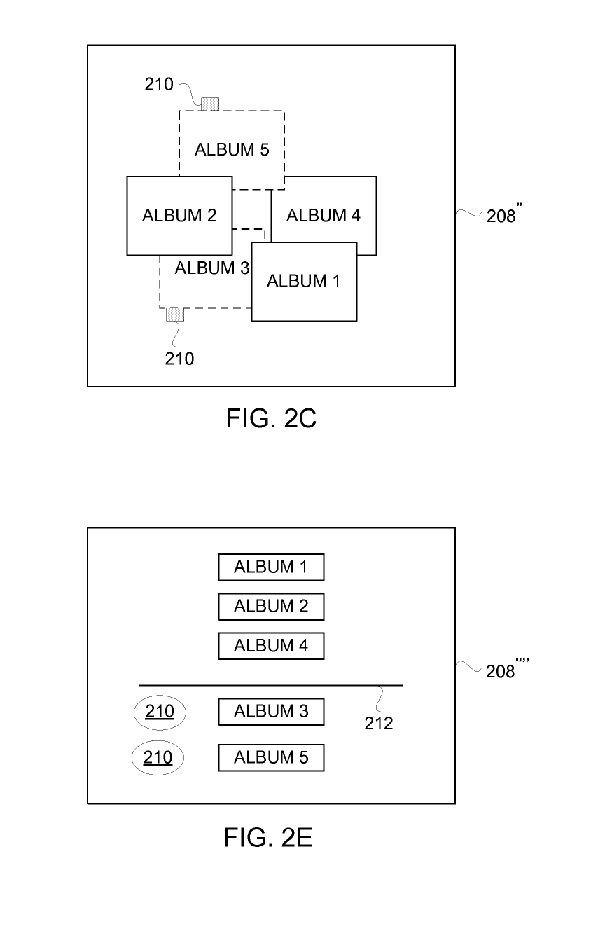

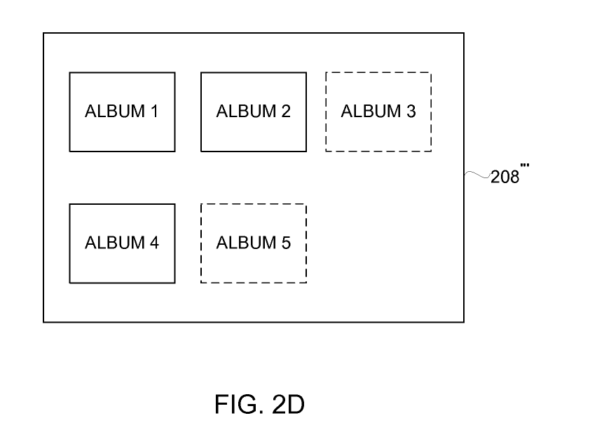

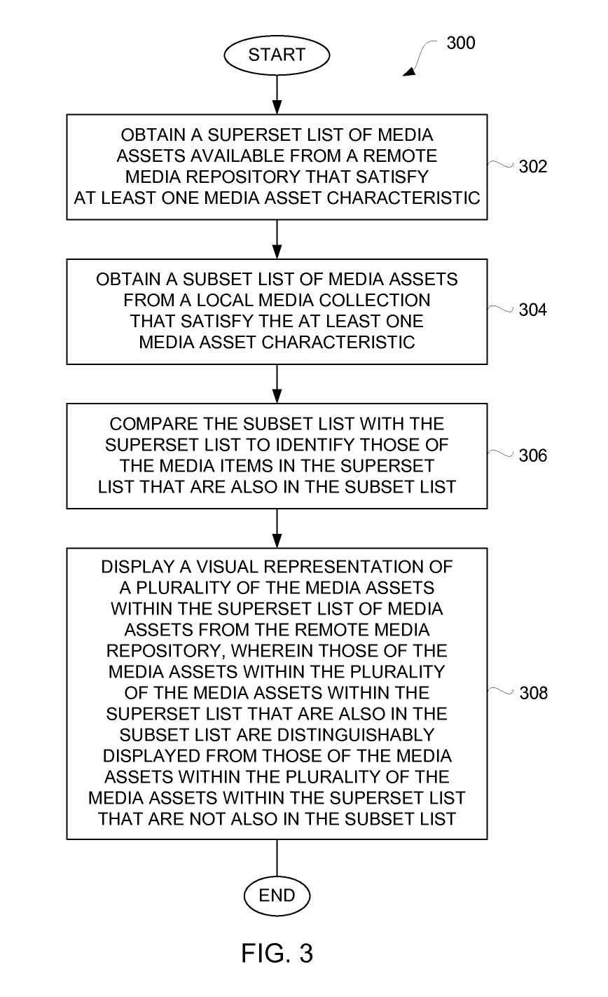

FIG. 2A is an illustration of a media presentation system 200 according to one embodiment of the invention. The media presentation system 200 includes a presentation manager 202. The media presentation manager 202 can be implemented by software or hardware. With respect to the computing device 100 illustrated in FIG. 1, the controller 102 can implement the media presentation system 200. The presentation manager 202 can access a local media collection 204 and a remote media library 206. Typically, the local media collection 204 represents only a small portion of the remote media library 206. However, in some cases the local media collection 204 could include media assets that are not within the remote media library 206. The remote media library 206 can also be referred to as a remote media collection.

The presentation manager 202 can produce a mixed media view 208. The mixed media view 208 is formed by the presentation manager 202 based on information concerning the media assets in the local media collection 204 and media assets in the remote media library 206. The mixed media view 208 can present the relationship of the media assets within the local media collection 204 as compared to the media assets within the remote media library 206. The mixed media view 208 can be created and presented on a display screen of a display device for a user. The mixed media view 208 facilitates presenting to the user a relevant portion of the local media collection 204 together with any relevant portion of the remote media library 206. The user is thus able to readily understand the relationship of the media assets within the local media collection 204 as compared to the media assets within the remote media library 206. For example, by presenting these media assets in the context of each other, the user is able to easily understand those additional media assets available from the remote media library 206 that are not within the local media collection 204. The user can also be assisted, if desired, to acquire one or more of the media assets within the remote media library 206 to enhance the media assets in the local media collection 204. Stated another way, by presenting these media assets in the context of each other, the user is able to easily understand those that the user already has personal access to (e.g., owns) as well as other related additional media assets that the user does not presently have personal access to (e.g., does not own) but could acquire personal access.

FIG. 2B is an illustration of an exemplary usage of a media presentation system 200′ according to one embodiment of the invention. The media presentation system 200′ represents an example of the media presentation system 200 illustrated in FIG. 2A with respect to exemplary media assets. The media presentation system 200′ include a presentation manager 202′ that can access local media collection 204′ and a remote media library 206′. In this example, the exemplary media assets are albums of songs. The remote media library 206′ includes various digital media assets including Album 1, Album 2, Album 3, Album 4 and Album 5. The local media collection 204′ includes substantially fewer digital media assets than does the remote media library 206′ but does include Album 1, Album 2 and Album 4. The presentation manager 202′ can provide a mixed media view 208′ of media assets within the local media collection 204′ and/or the remote media library 206′. The mixed media view 208′ is a view of the relevant portion of the local media collection 204′ together with any relevant portion of the remote media library 206′. In this example, the mixed media view 206′ includes Albums 1, 2, 3, 4 and 5. The digital media assets, e.g., albums, in the mixed media view 206′ can be ordered and provided in any of a variety of presentation formats. As shown in FIG. 2B, the ordering of the albums is sequential and the format is partially overlapped and extending to the upper-right. It should be noted that, as presented in the mixed media view 208′, the albums 3 and 5 are shown as broken lines (e.g., dotted lines) to signify that these albums are not within the local media collection 204′ but are within the remote media library 206′. The albums 3 and 5 can alternatively (or additionally) be visually designated with a lowered opacity, as grayed-out appearance or other visual indicator to signify that these albums are not within the local media collection 204′ but are within the remote media library 206′. By presenting these media assets in the context of each other, the user is able to easily understand those additional media assets available from the remote media library 206′ that are not within the local media collection 204′.

Optionally, the mixed media view 208′ can also include one or more user interface controls 210 (e.g., selectable button(s)) that a user can select to facilitate acquisition (e.g., purchase) of the corresponding digital media asset. The one or more user interface controls 210 can be visual elements associated with those additional media assets available from the remote media library 206′ that are not within the local media collection 204′. For example, the user interface controls 210 can be implemented as virtual buttons that are linked to remotely located information on one or more of the additional media assets available from the remote media library 206′. If the user proceeds to acquire one or more of the additional media assets, the acquired digital media assets can be added to the local media collection 204′.

FIG. 2C illustrated a first alternative presentation for a mixed media view 208″ according to one embodiment. The mixed media view 208″ can present the same media assets as the mixed media view 208′, but in a different presentation format. The presentation format for the mixed media view 208″ shown in FIG. 2C is a cluster format. As presented in the mixed media view 208″, the albums 3 and 5 are shown (by broken lines (e.g., dotted lines) or other ways) that these albums are not within the local media collection 204′ but are within the remote media library 206′. By presenting these media assets in the context of each other using the cluster format, the user is able to easily understand those additional media assets available from the remote media library 206′ that are not within the local media collection 204′.

FIG. 2D illustrated a second alternative presentation for a mixed media view 208′″ according to one embodiment. The mixed media view 208′″ can present the same media assets as the mixed media view 208′, but in a different presentation format. The presentation format for the mixed media view 208′″ shown in FIG. 2D is a grid format. As presented in the mixed media view 208′″, the albums 3 and 5 are shown (by broken lines (e.g., dotted lines) or other ways) that these albums are not within the local media collection 204′ but are within the remote media library 206′. By presenting these media assets in the context of each other using the grid format, the user is able to easily understand those additional media assets available from the remote media library 206′ that are not within the local media collection 204′.

FIG. 2E illustrated a third alternative presentation for a mixed media view 208″″ according to one embodiment. The mixed media view 208″″ can present the same media assets as the mixed media view 208′, albeit in a different presentation format. The presentation format for the mixed media view 208″″ shown in FIG. 2E is a timeline format. As presented in the mixed media view 208″″, the albums 3 and 5 are shown below a timeline 212 because these albums are not within the local media collection 204′ but are within the remote media library 206′. By presenting these media assets in the context of each other using the timeline format, the user is able to easily understand those additional media assets available from the remote media library 206′ that are not within the local media collection 204′. The albums 3 and 5 can alternatively (or additionally) also visually designate the albums 3 and 5 by broken lines (e.g., dotted lines), a lowered opacity, a grayed-out appearance or other visual indicator to signify that these albums are not within the local media collection 204′ but are within the remote media library 206′.

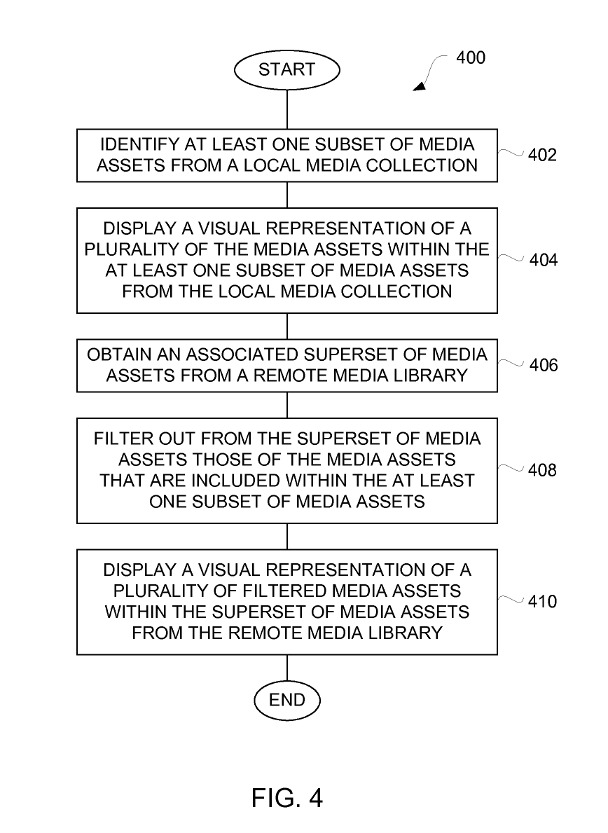

FIG. 3 is a flow diagram of a media presentation process 300 according to one embodiment of the invention. The media presentation process 300 can, for example, be performed by a computing device, such as a computing device 100 illustrated in FIG. 1. Alternatively, the media presentation process 300 can, for example, be performed by the presentation manager 202.

The media presentation process 300 can obtain 302 a superset list of media assets available from a remote media repository. Typically, the superset list of media assets is a portion of the large number of media assets available from the remote media repository. In one implementation, the superset list of media assets is a set of media assets available from the remote media repository that satisfy at least one media asset characteristic. In one embodiment, the at least one media asset characteristic can be used to filter out those media assets in the remote media repository a user is not presently interested in viewing (i.e., unwanted media assets). The media asset characteristic can be associated with metadata for the digital media assets. For example, although the media asset characteristic can vary widely, a few examples can limit media assets based on: artist name, album name, podcast name, movie name, genre, year of release, etc. For example, the artist name can be used to limit the superset list of media assets to those media assets in the remote media repository that have a matching artist name (e.g., “ACDC”). As another example, the year of release can be used to limit the superset list of media assets to those media assets in the remote media repository that have a matching year of release (e.g., 1980-1985). The remote media repository can pertain to a remote media library. The remote media repository can also pertain to media assets that are available for preview, license or purchase from an online media store. One example of an online media store is the iTunes™ store, provided by Apple Inc. of Cupertino, Calif.

A subset list of media assets available from a local media collection can also be obtained 304. The media assets within the subset list can be those media assets within the local media collection that satisfy the at least one media characteristic. In one implementation, the subset list of media assets is a set of media assets available from the local media collection (e.g., stored on the computing device). In one embodiment, the at least one media asset characteristic can be used to filter out those media assets in the local media collection a user is not presently interested in viewing (i.e., unwanted media assets). As noted above, the media asset characteristic can be associated with metadata for the digital media assets.

Next, the subset list can be compared 306 with the superset list to identify those of the media items in the superset list that are also in the subset list. A visual representation of at least a plurality of the media assets within the superset list of media assets from the remote media repository can then be displayed 308. More particularly, those of the media assets within the plurality of the media assets within the superset list that are also in the subset list can be distinguishably displayed from those of the media assets within the plurality of the media assets within the superset list that are not also in the subset list. Consequently, the visual representation presents the subset list in context with the superset list. As a result, the users of the computing device performing the media presentation process 300 sees the visual presentation that is displayed and can thus visually recognize what media assets are in the possession of (e.g., owned by) the user and what other media assets that exist but are not presently in the possession of the user. Following the block 308, the media presentation process 300 can end.

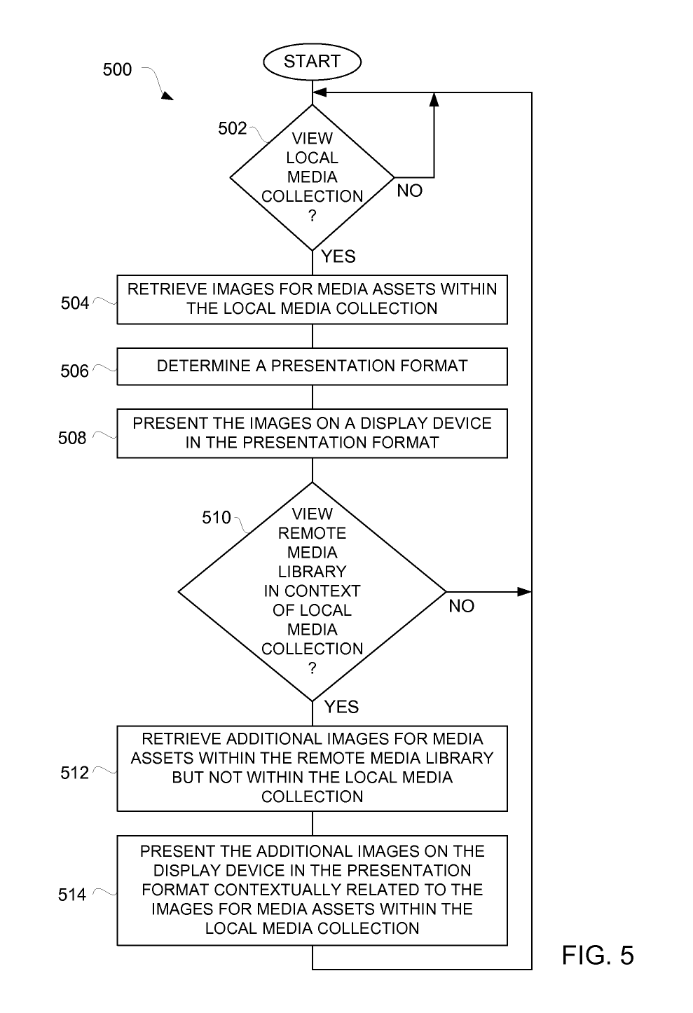

FIG. 4 is a flow diagram of a media presentation process 400 according to one embodiment of the invention. The media presentation process 400 can, for example, be performed by a computing device, such as a computing device 100 illustrated in FIG. 1. Alternatively, the media presentation process 400 can, for example, be performed by the presentation manager 202.

The media presentation process 400 can identify 402 at least one subset of media assets from a local media collection. A visual representation of the plurality of the media assets within the at least one subset of media assets from the local media collection can then be displayed 404. The visual representation can have any of a number of different formats. For example, the visual representation can be a cluster format, a grid format or a timeline format. Additionally, an associated superset of media assets can be obtained 406 from a remote media library. In one embodiment, the associated superset of media assets are those media assets within the remote media library that are within or which can bolster the local media collection. Those of the media assets from the remote media library that are included within the at least one subset of media assets can be filtered out 408 from the superset of media assets. The media assets remaining in the superset of media assets after the filtering 408 can be referred to as filtered media assets. Thereafter, a visual representation of a plurality of the filtered media assets from the remote media library can be displayed 410. Here, when the visual representation of a plurality of the filtered media assets from the remote media library is displayed 410, the visual representation of the plurality of the media assets within the at least one subset of media assets from the local media collection is being displayed 404. These visual representations can be separate or can be combined or integrated into a single visual representation. Following the block 410, and the media presentation process 400 can end.

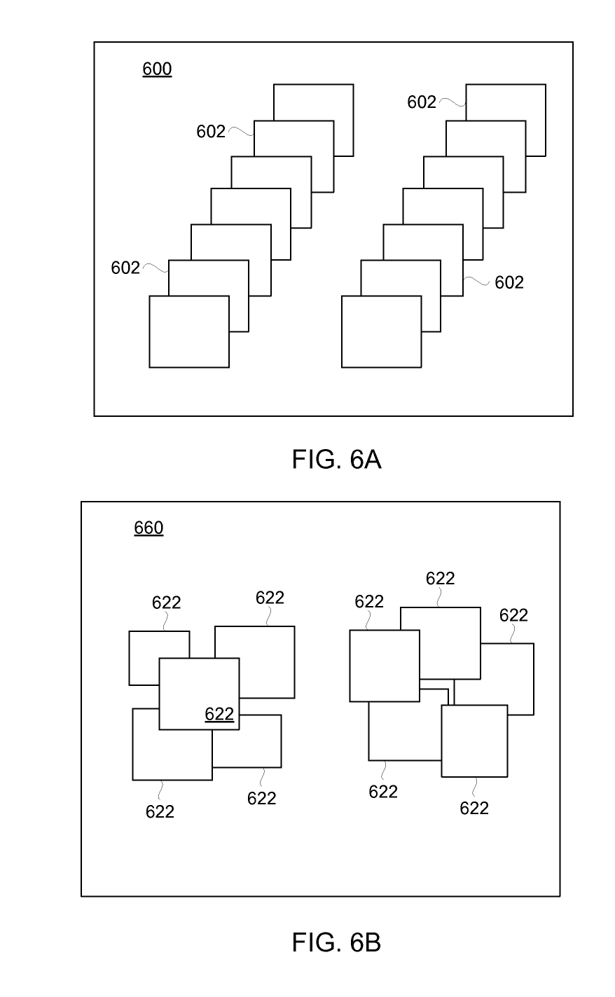

FIG. 5 is a flow diagram of a media presentation process 500 according to one embodiment of the invention. The media presentation process 500 can, for example, be performed by a computing device, such as the computing device 100 illustrated in FIG. 1. Alternatively, the media presentation process 500 can, for example, be performed by the presentation manager 202.

The media presentation process 500 can begin with a decision 502 that determines whether a local media collection is to be viewed. Here, the decision 502 can be determined by the computing device with or without the assistance of user input. In any case, when the decision 502 determines that a local media collection is not to be viewed at this time, the media presentation process 500 can await for the need to present information concerning a local media collection.

On the other hand, when the decision 502 determines that a local media collection is to be viewed, images for media assets within the local media collection can be retrieved 504. A presentation format for the various images of media assets to be displayed can be determined 506. The presentation format controls how the various images will be displayed on a display screen. The presentation format can, for example, be determined 506 based on a user selection or a default selection. Although the presentation formats can vary with different embodiment, some examples of presentation formats are a grid format, a cluster format or a timeline format. The images for the media assets within the local media collection can be presented 508 in accordance with the presentation format.

Next, a decision 510 determines whether a remote media library is to be viewed in context of a local media collection. When the decision 510 determines that a remote media library is not to be viewed in context of a local media collection, the media presentation process 500 can return to repeat the decision 502 and subsequent blocks. Alternatively, when the decision 510 determines that a remote media library is to be viewed in context of a local media collection, additional images for media assets within the remote media library but not within the local media collection can be retrieved 512. The additional images can then be presented 514 on the display device in accordance with the presentation format. Here, the additional images can be presented 514 such that they are contextually related to the images for the media assets within the local media collection. Following the block 514, the media presentation process 500 can return to repeat the decision 502 and subsequent blocks.

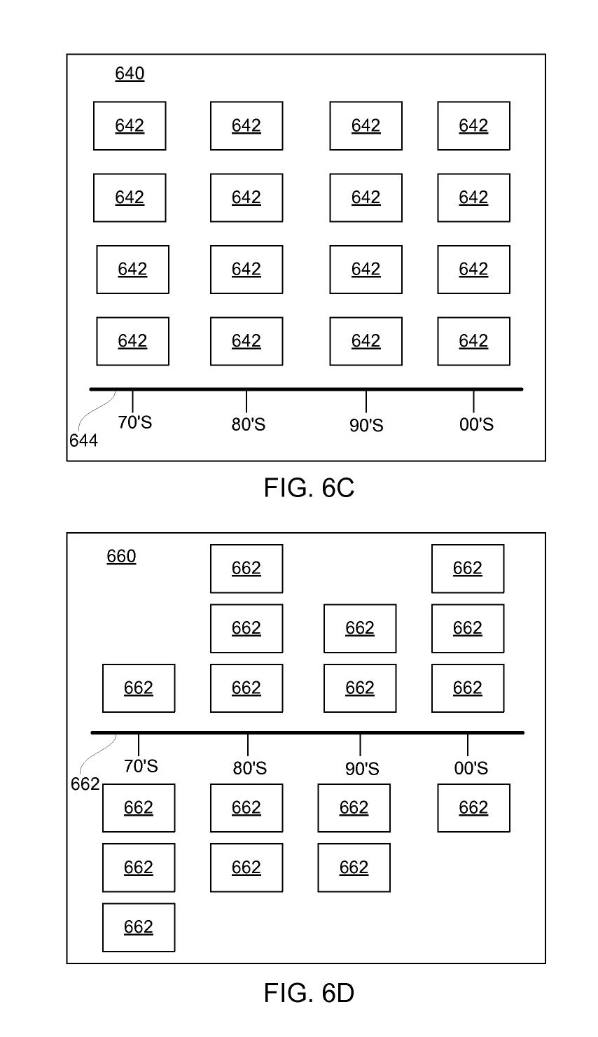

FIGS. 6A-6D are exemplary visual representations according to embodiments of the invention. The visual representations can be provided by the computing system 100 or any of the media presentation processes 300, 400 500 of FIG. 3, 4 or 5 as discussed above. The visual representations can also correspond to the mixed media view 208 illustrated in FIG. 2A.

FIG. 6A illustrates a first exemplary media presentation 600. The first exemplary media presentation 600 includes a plurality of partially overlapping images 602 pertaining to and representing different digital media assets. In this example, there are two sets of partially overlapping images. However, in general, one or more sets of partially overlapping images can be presented (i.e., displayed). The visual depiction of the images 602 representing media assets available locally can be presented differently than those of the images 602 representing media assets not available locally but available remotely. For example, visual depiction can use a visual effect or display a visual indicator to thus provide a visually distinguishing characteristic (e.g., shape, side, shading, opacity, broken-line, color, or marking) to appropriate ones of the images 602.

FIG. 6B illustrates a second exemplary media presentation 620. The second exemplary media presentation 620 includes a plurality of clustered images 622 pertaining to and representing different digital media assets. The images arranged in a given cluster are typically related to one another and the arrangement of the cluster and the images therein can vary based on the relationships. In this example, there are two sets of image clusters, which certain of the images being fully visible and other of the images being partially overlapped. However, in general, one or more sets of image clusters can be presented (i.e., displayed). The visual depiction of the images 622 representing media assets available locally can be presented differently than those of the images 622 representing media assets not available locally but available remotely. For example, visual depiction can use a visual effect or display a visual indicator to thus provide a visually distinguishing characteristic (e.g., shape, side, shading, opacity, broken-line, color, or marking) to appropriate ones of the images 622.

FIG. 6C illustrates a third exemplary media presentation 640. The third exemplary media presentation 640 includes a plurality of non-overlapping images 642 pertaining to and representing different digital media assets. The different digital media assets can pertain to a subset of media assets, such as limited to a genre, artist, time, etc. As shown in FIG. 6C, the images 642 are arranged in a grid layout in accordance with a timeline 644. Here, the timeline 644 is divided into decades of release dates. The visual depiction of the images 642 representing media assets available locally can be presented differently than those of the images 642 representing media assets not available locally but available remotely. For example, visual depiction can use a visual effect or display a visual indicator to thus provide a visually distinguishing characteristic (e.g., shape, side, shading, opacity, broken-line, color, or marking) to appropriate ones of the images 642.

FIG. 6D illustrates a fourth exemplary media presentation 660. The fourth exemplary media presentation 660 includes a plurality of non-overlapping images 662 pertaining to and representing different digital media assets. The different digital media assets can pertain to a subset of media assets, such as limited to a genre, artist, time, etc. As shown in FIG. 6D, the images 662 are arranged in a column layout in accordance with a timeline 664. In this embodiment, the images 662 representing media assets available locally can be presented above the timeline 664, while the images 662 representing media assets not available locally but available remotely can be presented below the timeline 664. Here, the timeline 664 is divided into decades of release dates. Optionally, the visual depiction of the images 662 representing media assets available locally can be presented differently than those of the images 662 representing media assets not available locally but available remotely. For example, visual depiction can use a visual effect or display a visual indicator to thus provide a visually distinguishing characteristic (e.g., shape, side, shading, opacity, broken-line, color, or marking) to appropriate ones of the images 662.

The ordering of the images associated with media assets within the groupings (e.g., clusters, stacks, grids, timelines, etc.) discussed above can be based various attributes of metadata or other data. As few examples, ordering can be alphabetical, by date (e.g., release date), popularity (aggregated popularity data), or play count.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method performed by a computer to present a representation of media assets on a display screen associated with the computer, said method comprising:
obtaining a superset list of media assets available from a remote media repository that satisfy at least one media asset characteristic;
obtaining a subset list of media assets from a local media collection stored on the computer that satisfy the at least one media asset characteristic;
comparing the subset list with the superset list to identify those of the media items in the superset list that are also in the subset list; and
displaying, on the display screen, a visual representation of (i) a plurality of the media assets within the superset list of media assets from the remote media repository and (ii) a plurality of the media assets within the subset list of media assets from the local media collection, wherein those of the media assets within the plurality of the media assets within the superset list that are also in the subset list are distinguishably displayed from those of the media assets within the plurality of the media assets within the superset list that are not also in the subset list.

2. A method as recited in claim 1, wherein the visual representation presents the media assets from the subset list in context of the media assets in the superset.

3. A method as recited in claim 1, wherein the visual representation presents the media assets from the subset list intermixed with the media assets in the superset.

4. A method as recited in claim 1, wherein the visual representation presents the media assets from the subset list adjacent with the media assets in the superset.

5. A method as recited in claim 1, wherein said displaying comprises:
displaying, on the display screen, an interrelated visual representation of (i) a plurality of media assets within the superset list of media assets from the remote media library, and (ii) a plurality of the media assets within the at least one subset of media assets from the local media collection.

6. A method as recited in claim 1, wherein those of the media assets within the plurality of the media assets within the superset list that are also within the subset list are displayed with normal opacity, and wherein those of the media assets within the plurality of the media assets within the superset list that are not also in the subset list are displayed with reduced opacity.

7. A method as recited in claim 1, wherein said displaying of the visual representation comprises displaying a series of images corresponding to the respective media assets.

8. A method as recited in claim 7, wherein each of the images corresponding to the respective media assets includes an ownership indicator.

9. A method as recited in claim 1, wherein the media assets with the visual representation are displayed in an order by date, popularity or play count.

10. A method as recited in claim 1, wherein the visual representation presents a partially overlapping stack of images associated with at least a plurality of the media assets,

11. A method as recited in claim 10, wherein any of the images in the stack of images is user-selectable.

12. A method as recited in claim 11, wherein on selection of one of the images in the stack of images, said method further comprises:
determining whether one of the images in the stack of images has been selected; and
causing the selected image, or information pertaining to the media asset associated with the selected image, to be provided in a foreground presentation on the display screen.

13. A method as recited in claim 1, wherein the visual representation presents a timeline and presents the media assets being displayed with reference to the timeline.

14. A method as recited in claim 13, wherein the media assets are displayed in relation to the timeline based on their date of release.

15. A method performed by a computer to present a representation of media assets on a display screen associated with the computer, said method comprising:
identifying at least one subset of media assets from a local media library stored on the computer, the at least one subset being defined by at least one subset characteristic;
displaying, on the display screen, a visual representation of a plurality of the media assets within the at least one subset of media assets from the local media library;
obtaining a superset of media assets from a remote media library that satisfy the at least one subset characteristic;
filtering out from the superset of media assets those of the media assets that are included within the at least one subset of media assets from the local media library; and
displaying, on the display screen, a visual representation of a plurality of those media assets within the filtered superset of media assets from the remote media library.

16. A method as recited in claim 15, wherein said displaying of the visual representation of a plurality of those media assets within the filtered superset such that the visual representation for such media assets is visually distinguishable the visual representation of the media assets within the at least one subset of media assets.

17. A method as recited in claim 15, wherein said displaying of the visual representation of the plurality of those media assets within the filtered superset displays an image for each of the media assets, and wherein said displaying of the plurality of the media assets within the at least one subset of media assets displays an image for each of the plurality of the media assets.

18. A method as recited in claim 17, wherein the images for each of the media assets within the filtered superset are displayed with less opacity than the opacity of the images for each of the plurality of the media assets within the at least one subset of media assets being displayed.

19. A method as recited in claim 15, wherein the visual representation of the plurality of the media assets within the at least one subset of media assets from the local media library and the visual representation of the plurality of those media assets within the filtered superset of media assets from the remote media library are displayed concurrently.

20. A method as recited in claim 15, wherein the visual representation of the plurality of the media assets within the at least one subset of media assets from the local media library and the visual representation of the plurality of the media assets within the filtered superset of media assets from the remote media library are intermixed and concurrently displayed.

21. A method as recited in claim 15, wherein the visual representation of the plurality of the media assets within the filtered superset of media assets from the remote media library is visually distinguished from the visual representation of the plurality of the media assets within the at least one subset of media assets from the local media library.

22. A method as recited in claim 15, wherein the visual representation of the plurality of the media assets within the filtered superset of media assets from the remote media library includes display of a series of images having a non-ownership indicator, and wherein the visual representation of the plurality of the media assets within the at least one subset of media assets from the local media library includes display of a series of images having an ownership indicator.

23. A method as recited in claim 22, wherein the non-ownership indicator is provided through reduced opacity of the images corresponding to the media asset within the filtered superset.

24. A computer-implemented method for visually representing media items on a display device, said method comprising:
determining media identifiers for a library of media items;
receiving a collection list for a predetermined collection of media items, the collection list having a collection list of media identifiers;
evaluating whether the media identifiers of the library match the media identifiers of the collection list; and
displaying a visual representation of the media items in the collection list in relation to media items in the library that the evaluating indicates are not in the collection list for the predetermined collection.
